(19) United States
(12) Patent Application Publication
(10) Pub. No.: US 2007/0127556 A1
(43) Pub. Date: Jun. 7, 2007

(54) Rake reception device and rake reception method

(75) Inventor: Takaaki Sato, Yokohama-shi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., OSAKA (JP)

(21) Appl. No.: 10/588,149

(22) PCT Filed: Feb. 3, 2004
(86) PCT No.: PCT/JP04/01045

§ 371 Date: Aug. 1, 2006

(51) Int. Cl. H04B 1/00

(52) U.S. Cl. 375/148

(57) ABSTRACT

A RAKE reception device capable of allocating an appropriate number of fingers to a channel. In this device, a selection control section (301) sets a finger (304) allocated to the channel from the channel communication state and a control signal based on this setting is output to a synchronization processing section (302) and to a selection switch (303). According to the control signal, the synchronization processing section (302) detects a path and a spread code phase in a reception signal and allocates the detected path to the finger (304) which has been set. The finger (304) which has been set de-spreads the signal of the path allocated and performs coherent detection. According to the control signal, the selection switch (303) switches the connection between the finger (304) and a maximum ratio combining section (307) so that the output from the finger (304) is output to the maximum ratio combining section (307).

### TECHNICAL FIELD

The present invention relates to a RAKE receiving apparatus and RAKE receiving method.

### BACKGROUND ART

CDMA (Code Division Multiple Access) receiving apparatus is used in mobile communication system such as automobile telephones and cellular telephones, and adopts CDMA scheme for radio access scheme. Such CDMA receiving apparatus identifies a channel on a radio channel by a spreading code. Abase station equipped with such CDMA receiving apparatus generally performs RAKE reception for receiving and combining radio signals transmitted from a mobile station as a plurality of propagation paths.

FIG. 1 is a block diagram showing a configuration of a conventional CDMA receiving apparatus. In FIG. 1, a RF (Radio Frequency) signal transmitted from the transmitting side via a channel is received at antenna 10, down-converted to a baseband signal (received signal) at radio section 20, and then RAKE reception is performed on a plurality (for example, K) of RAKE receivers 30-1, 30-2, . . . , and 30-K. In addition, since RAKE receivers 30-1 to 30-K all have the same configuration, an arbitrary RAKE receiver will be indicated as “30.”

Upon starting reception, RAKE receiver 30 obtains the spreading codes for the receiving channels at synchronization processing section 31 from control section (not shown) which controls the CDMA receiving apparatus. Then, a plurality of paths and spreading code phases are detected from received signals at synchronization processing section 31. The detected paths are allocated to a plurality (for example, N) of fingers 32-1, 32-2, . . . , and 32-N, respectively. In fingers 32-1 to 32-N, based on the detected spreading code phases, despreading sections 33-1, 33-2, . . . , and 33-N despread the allocated path signals, and coherent detection sections 34-1, 34-2, . . . , and 34-N subsequently performs coherent detection on the despread signals. Then, maximum ratio combining section 35 assigns predetermined weight and performs maximum ratio combining to output signals from fingers 32-1 to 32-N (namely, coherent-detected signals), and outputs this result as a RAKE combining result.

However, RAKE receiver needs to use more fingers to obtain good reception characteristics under the multipath environment. On the other hand, RAKE receiver does not need to use fingers much when channels having high spreading factor are received and channels have good communication conditions. However, in the above mentioned conventional CDMA receiving apparatus, one RAKE receiver is always used per channel. Thus, N fingers are always allocated to the channel. This causes a problem that RAKE receiver provided with the conventional CDMA receiving apparatus cannot allocate the appropriate number of fingers per channel according to communication conditions. In other words, if the number (K) of RAKE receivers is increased to receive more channels, the number (K×N) of fingers in CDMA receiving apparatus increases. As a result, this causes a problem that there are many unused fingers in CDMA receiving apparatus.

### DISCLOSURE OF INVENTION

It is an object of the present invention to provide a RAKE receiving apparatus and RAKE receiving method capable of allocating an appropriate number of fingers to a channel.

According to an aspect of the present invention, RAKE receiving apparatus has a plurality of fingers and a setting section that sets at least one finger to be allocated to the received channel from the plurality of fingers.

According to another aspect of an invention, RAKE receiving apparatus has a receiving step that receives a channel and a setting step that sets at least one finger to be allocated to the received channel from the plurality of fingers.

### BRIEF DESCRIPTION OF DRAWINGS

FIG. 1 is a block diagram showing an example configuration of conventional CDMA receiving apparatus;

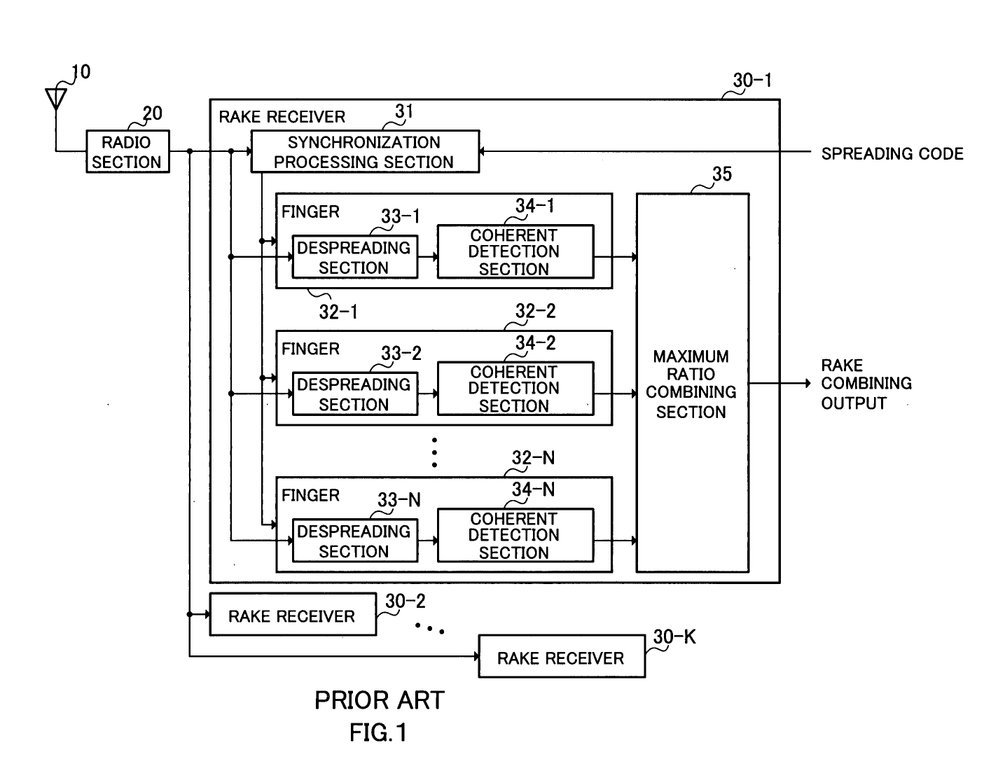

FIG. 2 is a block diagram showing a configuration of CDMA receiving apparatus according to an embodiment of the present invention;

FIG. 3 is a block diagram showing an example configuration of switching control section according to the embodiment;

FIG. 4 is a flow chart illustrating an operation of switching control section according to the embodiment;

FIG. 5 illustrates an example of a table according to the embodiment; and

FIG. 6 is a flowchart illustrating another operation of switching control section according to the embodiment.

### BEST MODE FOR CARRYING OUT THE INVENTION

It is a feature of the present invention to make variable number of fingers which are allocated to the received channel according to communication conditions.

Embodiments of the present invention will now be described in detail with reference to the accompanying drawings.

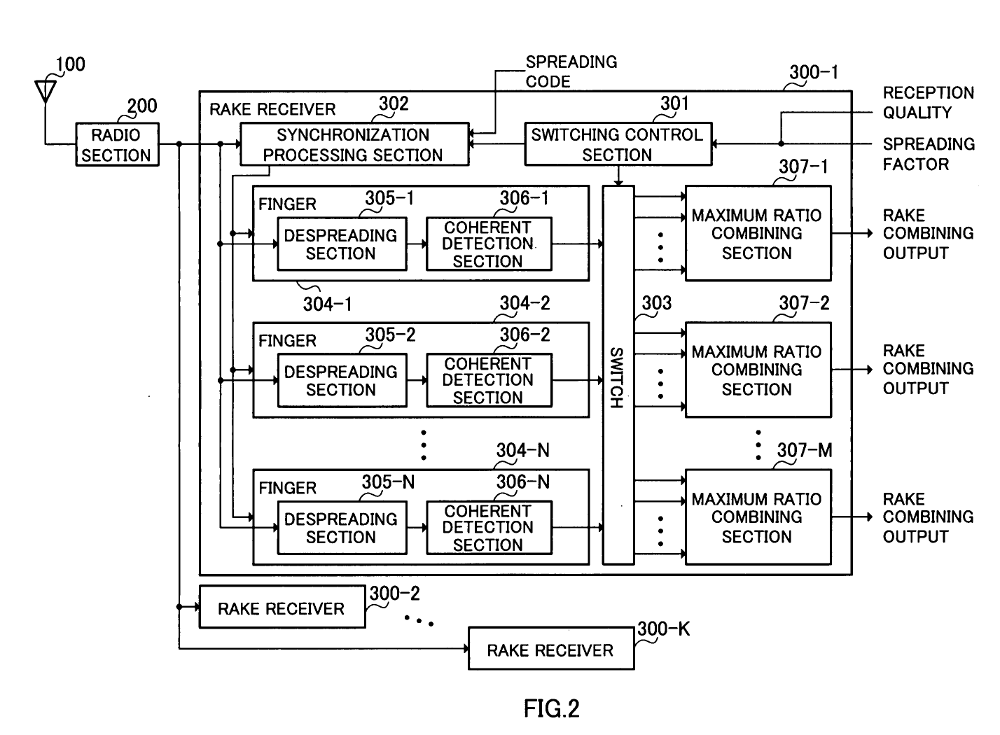

FIG. 2 is a block diagram showing a configuration of CDMA receiving apparatus according to an embodiment of the present invention.

The CDMA receiving apparatus shown in FIG. 2 is configured with antenna 100, radio section 200 that down-converts a RF signal received at antenna 100 via a channel to a baseband signal (received signal), and a plurality (for example, K) of RAKE receivers 300-1, 300-2, . . . , and 300-K that perform RAKE reception of received signals. Since RAKE receivers 300-1, 300-2, . . . , and 300-K all have the same configuration, an arbitrary RAKE receiver will be indicated as “300.”

RAKE receiver 300 has switching control section 301, synchronization processing section 302, switch 303, a plurality (for example, N) of fingers 304-1, 304-2, . . . , and 304-N, and a plurality (for example, M) of maximum ratio combining sections 307-1, 307-2, . . . , and 307-M. Fingers 304-1 to 304-N have despreading sections 305-1, 305-2, . . . , and 305-N, and coherent detection sections 306-1, 306-2, . . . , and 306-N, respectively. An arbitrary finger will be hereinafter referred to as “304,” and despreading section and coherent detection section which are included in arbitrary finger 304 will be indicated as “305” and “306,” respectively. Further, since maximum ratio combining sections 307-1 to 307-K all have the same configuration, an arbitrary maximum ratio combining sections will be hereinafter indicated as “307.”

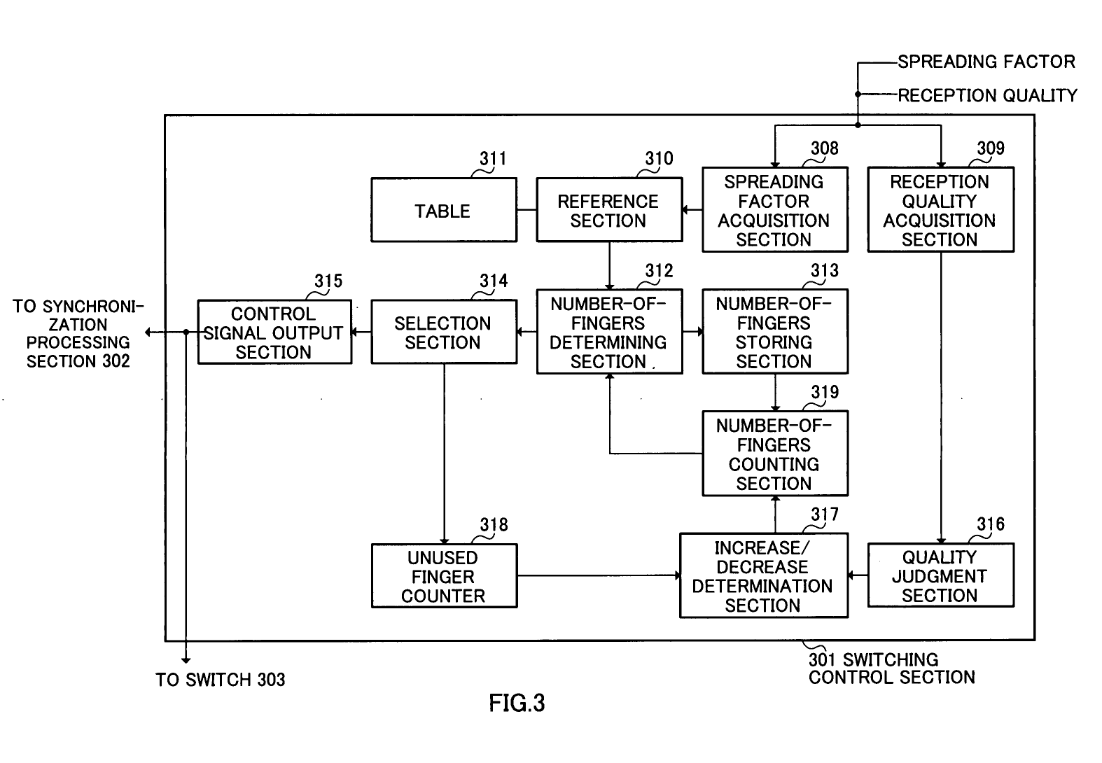

An example configuration of switching control section 301 as shown in FIG. 2 is illustrated in FIG. 3. Switching control section 301 has spreading factor acquisition section 308, reception quality acquisition section 309, reference section 310, table 311, number -of-fingers determining section 312, number-of-fingers storing section 313, selection section 314, control signal output section 315, quality judgment section 316, increase/decrease determination section 317, unused fingers counter 318 and number-of-fingers calculating section 319.

An operation of RAKE receiver 300 having the above configuration will now be described.

RAKE receiver 300 obtains communication conditions of channel (for example, spreading factor or reception quality of the channel) at switching control section 301. Then, control signal which allocates the number (for example, P) of fingers to channel based on communication conditions is outputted to synchronization processing section 302. Control signal which allocates P fingers and one maximum ratio combining section 307 to channel based on communication conditions is then outputted to switch 303. An operation of switching control section 301 will be described later.

In switch 303, in accordance with control signal, connection between finger 304 and maximum ratio combining section 307 provided inside RAKE receiver 300 are switched so that outputs from the allocated P fingers 304 are outputted to the allocated maximum ratio combining section 307.

In synchronization processing section 302, upon starting reception, spreading code for the received signals from control section (not shown) that controls CDMA receiving apparatus is obtained. Furthermore, when RAKE receiver 300 receives a plurality of channels, in synchronization processing section 302, a plurality of allocated spreading codes are retained. After obtaining the spreading codes, in synchronization processing section 302, in accordance with the control signal, a maximum of P paths and spreading code phases from received signals are detected and allocated to the selected fingers 304.

Then, in the selected P fingers 304, despreading section 305 despreads the allocated path signals, and coherent detection section 306 performs coherent detection on the despread signals and outputs coherent-detected signals to maximum ratio combining section 307 via switch 303.

In maximum ratio combining section 307, predetermined weight is assigned to output signals from P fingers 304, maximum ratio combining is performed, and the result is outputted as RAKE combining result.

When RAKE receiver 300 receives a plurality of channels, connection is switched so that the output signals from the selected fingers 304 for channels are outputted to different maximum ratio combining sections 307 per channels, and maximum ratio combining section 307 outputs RAKE combining result per channel.

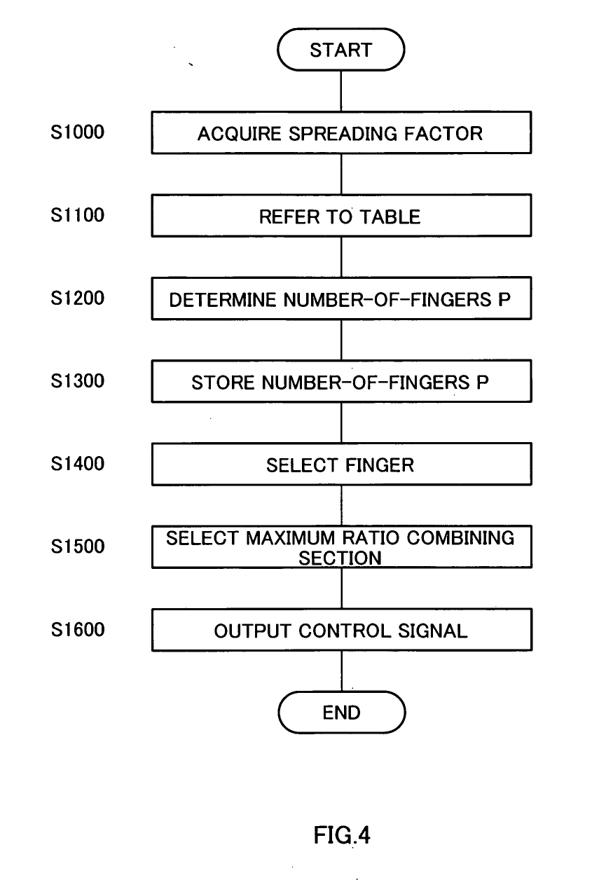

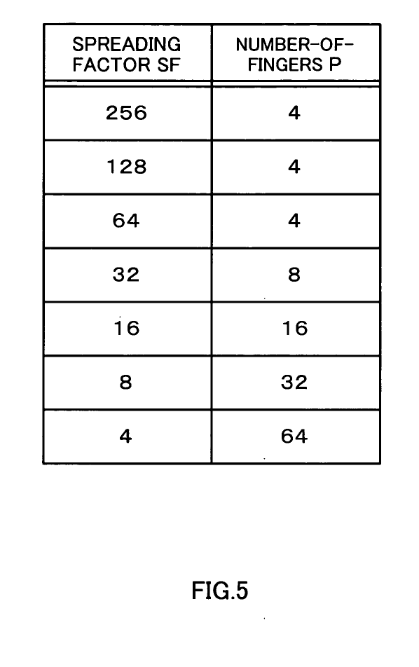

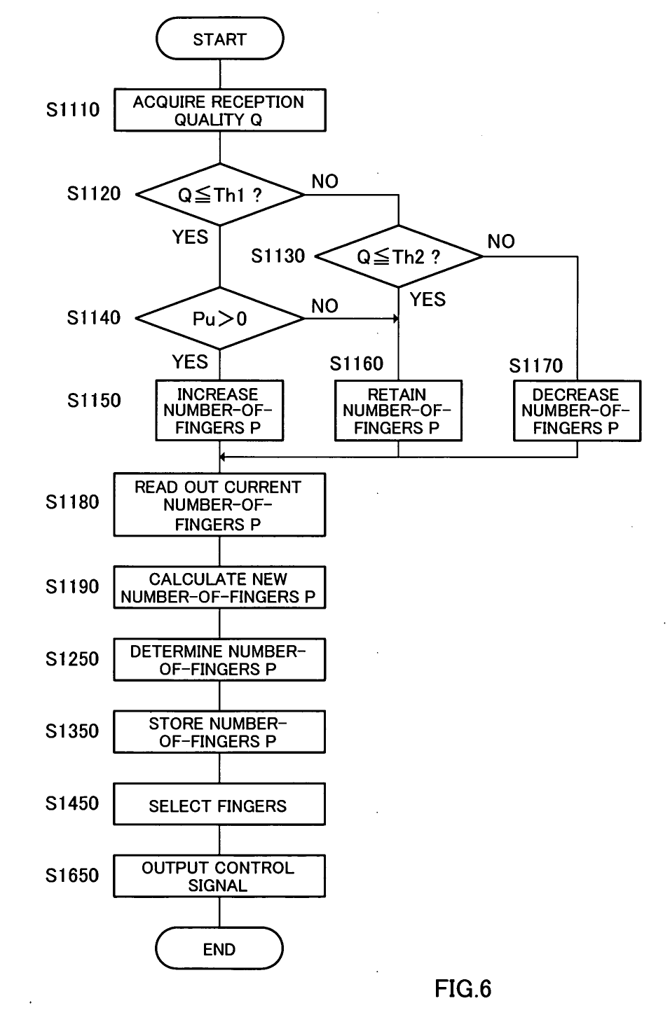

Next, an operation of switching control section 301 having the above configuration will be described using FIG. 4, FIG. 5 and FIG. 6. FIG. 4 is a flow chart illustrating an operation of switching control section 301, FIG. 5 illustrates an example of table 311, and FIG. 6 is a flow chart illustrating another operation of switching control section 301.

The operation of switching control section 301 when starting channel reception will be described using FIG. 4.

When RAKE receiver 300 starts receiving a channel, in step S1000, spreading factor acquisition section 308 acquires and outputs spreading factor SF of the channel to reference section 310. Spreading factor SF is obtained from control section (not shown) that controls CDMA receiving apparatus.

Then, in step S1100, reference section 310 refers to table 311 which stores the relationships between spreading factor SF and the number of P fingers, the number P corresponding to spreading factor SF is extracted and outputted to number-of-fingers determining section 311.

An example of table 311 is shown in FIG. 5. For example, when spreading factor SF1 for channel Ch1 which started reception is 256, the output value for this input value 256 is 4. In this case, when a scheme of making variable spreading factor according to data size (Dynamic rate matching) is adopted in uplink, SF1 may be the least spreading factor applicable to the channel. This scheme is described in 3GPP (3rd Generation Partnership Project) specification TS25.212. Channel having small spreading factor has smaller number of channels storable in radio channel than channel having large spreading factor. Therefore, by allocating more fingers to channel having small spreading factor, channel having small spreading factor is expected to obtain good reception characteristics at base station apparatus even if transmission power from mobile station apparatus is reduced.

Then, in step S1200, number-of-fingers determining section 312 determines the inputted numbers P as the number of fingers 304 which are allocated to channel, and outputs to number-of-fingers storing section 313 and selection section 314.

Then, in step S1300, number-of-fingers storing section 313 stores the number of fingers P which are allocated to channel.

Then, in step S1400, selection section 304 selects P fingers 304 from N fingers 304 provided inside RAKE receiver 300, and reports to control signal output section 315. More specifically, of N fingers 304, P fingers 304 are selected from fingers 304 which are not allocated to any channel then.

Then, in step S1500, selection section 314 selects one maximum ratio combining section 307 corresponding to P fingers 304 from M maximum ratio combining sections 307, and reports to control signal output section 315. More specifically, of M maximum ratio combining sections 307, one maximum ratio combining section 307 is selected from maximum ratio combining sections 307 which are not allocated to any channel then.

In addition, selection of maximum ratio combining section 307 in step S1500 is performed after selection of finger 304 as described above according to this embodiment, but selection may be performed after starting reception of channel.

Then, in step S1600, control signal output section 315 receives report from selection section, and outputs a control signal which allocates P fingers 304 for channel to synchronization processing section 302. Also, at the same time, control signal which allocates P fingers 304 and maximum ratio combining section 307 for channel is outputted to switch 303.

Next, an operation of switching control section 301 when channel is received will be explained using FIG. 6.

When RAKE receiver 300 receives channel, in step S1110, reception quality acquisition section 309 acquires and outputs reception quality Q of channel to quality judgment section 316.

Here, reception quality Q uses the values, for example, Physical channel BER (Bit Error Rate) (BER measured value for DPCCH (Dedicated Physical Control Channel) which is always transmitted in uplink), Transport channel BER (BER estimated value for DPDCH (Dedicated Physical Data Channel) after RAKE combining) which are stipulated in 3GPP specification, SIR (Signal to Interference Factor) and estimated value of maximum Doppler frequency.

A case has been described with this embodiment where an index whereby a greater value represents better reception quality is used, for example, SIR. However, it is possible to apply to a case where an index where a smaller value represents better reception quality is used, for example, Physical channel BER and Transport channel BER.

Then, in step S1120 and step S1130, quality judgment section 316 judges the reception quality Q using two threshold values Th1 and Tn2 (Th1<Th2). First, in step S1120, quality judgment section 316 compares reception quality Q with threshold value Th1. When the result of the comparison is Q≦Th1, the reception quality Q is determined as poor. When the result is Q>Th1, the reception quality Q is determined as good. When the reception quality Q is good, in step S1130, quality judgment section 316 compares the reception quality Q with threshold value Th2. When the result of the comparison is (Th1<)Q≦Th2, determination of the reception quality Q unchanged as poor. However, when the result is Q>Th2(>Th1), the determination of the reception quality Q is changed as very good.

Then, this quality judgment result is outputted to increase/decrease determination section 317. Then, in step S1140, step S1150, step S1160 and step S1170, increase/decrease determination section 317 determines whether or not the number of P fingers 304 which are allocated to reception channel then should be changed according to quality judgment result.

First, when the quality judgment result is poor (S1120:YES), in step S1140, increase/decrease determination section 317 refers to unused finger counter 318. Unused finger counter 318 monitors selection section 314, counts fingers 304 which are not allocated to any reception channel, and stores the numbers Pu. When the reference result is Pu>0 (S1140:YES), in step S1150, the number of fingers P is determined to be increased one by increase/decrease determination section 317 (output value=+1). On the other hand, when the reference result is Pu=0 (S1140:NO), in step S1160, increase/decrease determination section 317 determines not to change the number of fingers P (output value=0). Also, when step quality judgment result is determined as good (S1130:YES), in step S1160, the number of fingers P is determined not to change (output value=0). Further, when quality judgment result is very good (S1130:NO), in step S1170, the number of fingers P is determined to be decreased one (output value=−1).

In addition, increase/decrease of the number of P fingers maybe the fixed number such as above or may be variable based on the change rate of the value of the reception quality Q. Increase/decrease determination section 317 outputs the above output value according to the increase/decrease determination result to number-of-fingers counting section 319.

Then, in step S1180, number-of-fingers counting section 319 reads out the number of fingers P which are allocated to channel from number-of-fingers storing section 313.

Then, in step S1190, number-of-fingers calculating section 319 adds output value from increase/decrease determination section 317 to value of the number of fingers P read out from number-of-fingers storing section 313. New number of fingers P is calculated by this. Then, this calculation result is outputted to number-of-fingers determining section 312.

Then, in step S1250, number-of-fingers determining section 312 determines and outputs the number of fingers P received from number-of-fingers calculating section 319 as P fingers 304 which are allocated to channel to number-of-fingers storing section 313 and selection section 314.

Then, in step S1350, number-of-fingers storing section 313 updates and stores P fingers 304 which are allocated per channel.

Then, in step S1450, selection section 314 selects P fingers 304 of N fingers 340 which are provided in RAKE receiver 300. More specifically, of N fingers 304, P fingers 304 are selected from fingers 304 which are allocated to channel then and P fingers 304 which are not allocated to any channel then. Then, the selected P fingers 304 and the already selected maximum ratio combining section 307 are reported to control signal output section 315.

Then, in step S1650, control signal output section 315 outputs control signal which allocates P fingers 304 to channel to synchronization processing section 302. Also, at the same time, in step S1650, control signal which allocates P fingers 304 and maximum ratio combining section 307 to channel is outputted to the switch 303.

In addition, switching control section 301 is not limited to the above configuration. For example, selection of maximum ratio combining section 307 is performed by selection section 314 in this embodiment, but selection may be performed by part additionally provided inside or outside switching control section 301. In this case, control signal output section 315 outputs control signal which allocates P fingers 304 to channel to switch 303, and the above mentioned part outputs control signal which allocates one maximum ratio combining section 307 to channel to switch 303.

As described above, according to this embodiment, P fingers 304 are allocated to received channel from N fingers 304 provided inside RAKE receiver 300. Therefore, allocation of fingers 304 to received channel is variable, and the appropriate number of fingers 304 can be allocated.

Furthermore, according to this embodiment, since allocation of fingers 304 are performed based on spreading factor SF of channel, fingers 304 which are allocated to channel are variable according to spreading factor SF, and the appropriate number of fingers 304 can be always allocated.

Furthermore, according to this embodiment, since allocation of fingers 304 are performed based on the reception quality Q of channel, fingers 304 which are allocated to channel are variable according to the reception quality Q, and the appropriate number of fingers 304 can be always allocated.

Furthermore, according to this embodiment, since fingers P are appropriately selected in accordance with determined numbers P, fingers 304 which are allocated to received channel are variable, and the appropriate number of fingers P to a channel can be therefore allocated.

Furthermore, according to this embodiment, since switch 303 switches connection between fingers 304 and maximum ratio combining section 307 provided inside RAKE receiver 300, it is possible to allocate fingers 304 which are provided inside RAKE receiver 300 to a plurality of channels.

As described above, according to the present invention, it is possible to allocate appropriate number of fingers to channel.

The present application is based on Japanese Patent application No. 2002-237379 filed on Aug. 16, 2002, the entire contents of which is expressly incorporated by reference herein.

### INDUSTRIAL APPLICABILITY

The present invention is suitable as a RAKE receiving apparatus and RAKE receiving method used in radio receiving apparatus which adopts CDMA scheme for radio access scheme.

1-6. (canceled)

7. A radio receiving apparatus comprising:
a plurality of RAKE fingers; and
a controlling section that controls a number of RAKE fingers to be used for channel reception among the plurality of RAKE fingers based on a spreading factor of the channel, wherein:
the controlling section allocates a larger number of RAKE fingers to a channel having a smaller spreading factor, and a smaller number of RAKE fingers to a channel having a greater spreading factor.

8. The radio receiving apparatus according to claim 7, wherein:
the controlling section controls the number of RAKE fingers to be used for channel reception based on the spreading factor of the channel at the start of channel reception, and controls the number of RAKE fingers to be used for channel reception based on reception quality of the channel during channel reception.

9. The radio receiving apparatus according to claim 8, wherein:
the controlling section increases or decreases the number of RAKE fingers to be used for channel reception, said the number of RAKE fingers being increased or decreased in accordance with a variable based on a change rate of reception quality of the channel.

10. A CDMA receiving apparatus comprising the radio receiving apparatus according to claim 7.

11. A radio base station apparatus comprising the CDMA receiving apparatus according to claim 10.

12. A RAKE finger allocation method for controlling a number of RAKE fingers to be used for channel reception among a plurality of fingers; the method comprising the steps of:
allocating a larger number of RAKE fingers of the plurality of RAKE fingers to a channel having a smaller spreading factor; and
allocating a smaller number of RAKE fingers of the plurality of RAKE fingers to a channel having a greater spreading factor.
